(19) United States
(12) Patent Application Publication
(10) Pub. No.: US 2005/0108073 A1
(43) Pub. Date: May 19, 2005

(54) System and method for diagnosing production logistics abnormalities

(75) Inventor: Chen-Ching Chu, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/991,297

(22) Filed: Nov. 17, 2004

(30) Foreign Application Priority Data
Feb. 12, 2003 (TW) 92133872

(51) Int. Cl. G06F 17/60

(52) U.S. Cl. 705/7

(57) ABSTRACT

A system for diagnosing production logistics abnormalities includes a first server (11) and a second server (12). The second server transmits production logistics information to the first server. The first server analyzes the received information, and determines whether production logistics activities are abnormal. The first server includes: a data maintenance module (21) including a criteria setting sub-module (211) for setting diagnosis criteria; an account payable creation module (22) for creating an account payable including an account payable creation date when a material is purchased; an account receivable creation module (23) for creating an account receivable including an account receivable creation date when a product incorporating the material is sold; and an abnormality determining module (24) for comparing a time period between the account payable creation date and the account receivable creation date and a preset time interval, to determine whether the production logistics activities of the material are abnormal.

### BACKGROUND OF THE INVENTION

1. Field of the Invention

The present invention relates generally to logistics monitoring and managing systems and methods, and more particularly to a system and method for diagnosing abnormal production logistics activities of various kinds of materials in the possession of a manufacturer.

2. Description of the Related Art

Managing logistics is becoming increasingly important for enterprises, especially manufacturers, to operate smoothly and effectively. Logistics is key to reducing costs and improving competitive strength. Many manufacturers are now actively modernizing their logistics management to better control the flow of material and products. In particular, manufacturers are seeking to track the flow of material and products in real time.

The field of logistics management is relatively broad, and includes a wide range of systems for tracking, controlling and reporting logistics operations involving various types of materials. Automation is a primary goal in these logistics management systems. The widespread commercial availability of computer hardware and software for logistics applications has led to a relatively high degree of automation.

Automated logistics management systems have been disclosed in numerous patents and publications, such as U.S. Pat. No. 6,753,808 entitled “System and Method for Monitoring and Managing Logistics Employing Global Positioning Subsystem” and issued on Jun. 22, 2004. The system comprises a central managing device, a vehicle information inputting device, a material information inputting device, a central monitoring device, and a global positioning subsystem. Information input through the vehicle information inputting device and the material information inputting device is stored in the central managing device and can be accessed by the central monitoring device. Information on a current location of a vehicle transporting material is sent to a web server via the global positioning subsystem and accessed by the central monitoring device. The central monitoring device can control logistics by checking whether the current location of the vehicle is along a predetermined route of the vehicle.

Another pertinent patent disclosure is U.S. Pat. No. 6,704,626 entitled “Logistics System and Method with Position Control”, issued on Mar. 9, 2004. The patent provides a logistics system and method which utilizes vehicle position control for logistics operations, especially regarding the loading and unloading of material onto and from the vehicle. The position control can be GPS-based and/or based on linear movement of the vehicle, such as movement of a railcar along a rail track. A computer-based position control subsystem mounted on the vehicle is connected to and operates other vehicle-mounted devices and subsystems for performing the logistics functions.

However, the prior art systems are mainly focused on monitoring of one or several stages of activities in purchase logistics and distribution logistics, both of which can be classified under “external logistics.” No known system deals with managing production logistics activities of materials held by a manufacturer on its premises. In particular, no existing systems diagnose abnormal logistics activities during the course of a related production process. The smooth operation and effective control of such “internal logistics” cannot be ensured. Therefore, what is needed is a system and method for diagnosing production logistics abnormalities and thereby overcoming or ameliorating the above-described problems.

### SUMMARY OF THE INVENTION

A main objective of the present invention is to provide a system for diagnosing production logistics abnormalities, in which the system can conveniently identify abnormal production logistics activities of materials in the possession of a manufacturer.

Another objective of the present invention is to provide a method for diagnosing production logistics abnormalities utilizing the above system, in order to conveniently identify abnormal production logistics activities of materials in the possession of a manufacturer.

To accomplish the first above objective, a system for diagnosing production logistics abnormalities in accordance with a preferred embodiment of the present invention comprises a first server and a second server. The second server is used for transmitting production logistics information to the first server. The first server analyzes the received information, and determines whether production logistics activities of a material in the possession of a manufacturer are abnormal. The first server comprises: a data maintenance module for maintaining information needed for diagnosing the production logistics activities, the data maintenance module including a criteria setting sub-module for setting diagnosis criteria for the material; an account payable creation module for creating an account payable when the material is purchased, the account payable including an account payable creation date; an account receivable creation module for creating an account receivable when an end product incorporating the material is sold, the account receivable including an account receivable creation date; and an abnormality determining module for comparing a time period between the account payable creation date and the account receivable creation date of the material with a preset time interval, in order to determine whether the production logistics activities of the material are abnormal.

To accomplish the second above objective, the present invention provides a preferred method for diagnosing production logistics abnormalities of a material in the possession of a manufacturer. The method comprises the steps of: setting diagnosis criteria for abnormal production logistics activities, the diagnosis criteria including a preset time interval for the material; creating an account payable when the material is purchased, the account payable including an account payable creation date; receiving production logistics information of the material in the possession of the manufacturer; creating an account receivable when an end product incorporating the material is sold, the account receivable including an account receivable creation date; and comparing a time period between the account payable creation date and the account receivable creation date with a preset time interval, in order to determine whether the production logistics activities of the material are abnormal.

Other objects, advantages and novel features of the present invention will be drawn from the following detailed description of a preferred embodiment and the preferred method of the present invention with reference to the attached drawings, in which:

### BRIEF DESCRIPTION OF THE DRAWINGS

FIG. 1 is a schematic diagram of hardware configuration of a system for diagnosing production logistics abnormalities of various materials in the possession of a manufacturer in accordance with the preferred embodiment of the present invention;

FIG. 2 is a schematic diagram showing main function modules of a first server of the system of FIG. 1; and

FIG. 3 is a flow diagram of the preferred method for diagnosing abnormal production logistics activities of a material in the possession of the manufacturer, by utilizing the system of FIG. 1.

### DETAILED DESCRIPTION OF THE PREFERRED EMBODIMENT

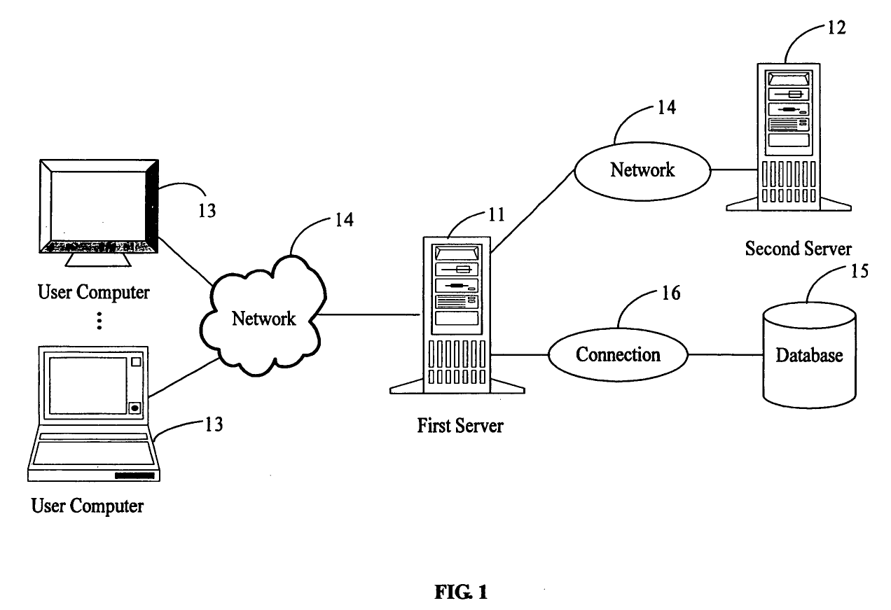

FIG. 1 is a schematic diagram of hardware configuration of a system for diagnosing production logistics abnormalities of various materials in the possession of a manufacturer (hereinafter “the system”) in accordance with the preferred embodiment of the present invention. The system is operated by the manufacturer, and comprises a first server 11, a second server 12, a plurality of user computers 13, and a database 15. The second server 12 and the user computers 13 are connected with the first server 11 through networks 14, which can jointly or separately be any one or more of the Internet, an intranet, and any other suitable means of electronic communication. The database 15 is linked to the first server 11 via a connection 16. The connection 16 is a kind of database connection, which may be an Open Database Connectivity (ODBC), a Java Database Connectivity (JDBC) or another suitable kind of connectivity.

The first server 11 contains a plurality of software modules installed therein, so that it can receive information input by users via the user computers 13 and information transmitted from the second server 12, analyze the received information, and generate analysis results. The analysis results are generally displayed in the form of reports and statements, which typically include detailed statements of accounts payable and accounts receivable, logistics activity analysis statements, and abnormality reports. The second server 12 is connectable to a manufacturing management system (not shown), which is also operated by the manufacturer. The manufacturing management system may be an Enterprise Resource Planning (ERP) system or like system. The second server 12 transmits production logistics information on the materials from the manufacturing management system to the first server 11. The production logistics information includes information related to the transformation, movement, storage and control of materials and related goods, from the time of acquisition of the materials by the manufacturer to the time of delivery of related end products to customers. Each user computer 13 provides a user interface. The user interface is for users to maintain the production logistics information, and for displaying the reports and statements generated by the first server 11. The database 15 is provided for storing the production logistics information, and reports used or generated by the system.

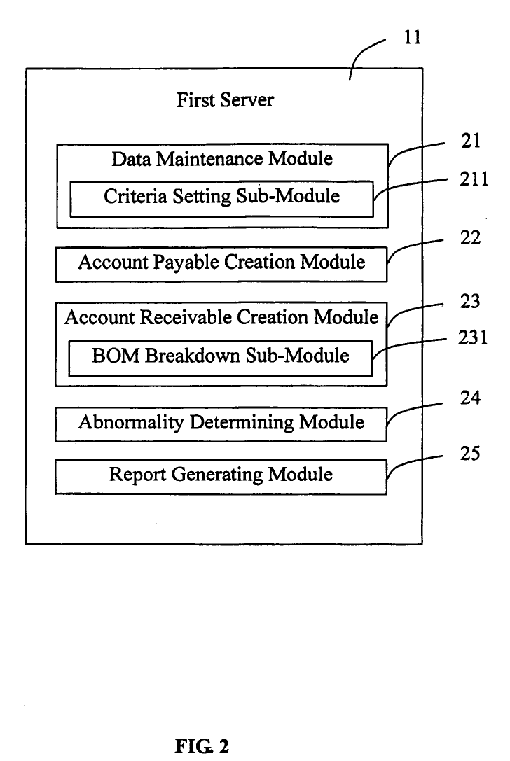

FIG. 2 is a schematic diagram of main software modules of the first server 11. The first server 11 comprises a data maintenance module 21, an account payable creation module 22, an account receivable creation module 23, an abnormality determining module 24, and a report generating module 25.

The data maintenance module 21 maintains various information on each material, the information being needed for diagnosing abnormal production logistics activities of the material. Such information includes diagnosis criteria for the material, an account payable created when the material is purchased, an account receivable created when an end product incorporating the material (and other materials) is sold, and templates for generating various reports. Each of the account payable and account receivable contains an account creation date. The maintenance includes operations of adding, deleting, editing and storing the information. The data maintenance module 21 further comprises a criteria setting sub-module 211, for users to set the diagnosis criteria for the material. In the preferred embodiment, the diagnosis criteria include a preset time interval for the material, and account creation dates of the material. The preset time interval specifies a maximum time during which the material can be kept by the manufacturer economically. The account creation dates are compared with the preset time interval, in order to determine whether production logistics activities of the material in the possession of the manufacturer are abnormal. Specifically, the criteria setting sub-module 211 sets (i) an account payable creation date of the material, namely a purchase date of the material, as a start point; and (ii) an account receivable creation date of the end product, as an end point. If a time period between the start point and the end point is less than or equal to the preset time interval, which may for example be 40 days, the production logistics activities of the material are considered as normal. Otherwise, if the time period exceeds 40 days, the production logistics activities of the material are considered as abnormal. In the latter case, root causes of the abnormalities are analyzed according to the production logistics information on the material, in order to avoid future similar abnormalities.

The account payable creation module 22 is used for creating the account payable when the material is purchased and put into storage. First, the second server 12 generates a goods receipt notice, and transmits the goods receipt notice to the first server 11. The goods receipt notice includes an item number of the material, a purchase quantity, a total amount, a receipt date, and payment terms. The account payable creation module 22 creates the account payable according to the goods receipt notice, and manages the account payable thereafter. Each time the account payable is handled at a particular stage, a flag is marked on the account payable to indicate a corresponding account status. For example, when the account payable is originally created, the account status is marked with “IV” (invoice verification). When the account payable has been verified by an accountant, the account status is marked with “AV” (accounting verification). When the accountant has made payment arrangements for the account payable, the account status is marked with “FV” (finance verification).

After certain production logistics activities, the material, along with other necessary materials or semi-finished products, is processed into the end product. When the end product is sold to a customer, the second server 12 generates a sales slip, and transmits the sales slip to the first server 11. The sales slip comprises a sale date and a sale price of the end product. Then, the account receivable creation module 23 creates an account receivable according to the sales slip, and stores the account receivable in the database 15. The account receivable creation module 23 further comprises a bill of material (BOM) breakdown sub-module 231, for breaking down a BOM of the end product to raw material levels and the account receivable into accounts receivable of all the constituent materials.

The abnormality determining module 24 compares the account payable with the account receivable to get a time period between the creation dates of the two accounts as an actual production information and determine whether the time period is less than or equal to the preset time interval. If the time period is less than or equal to the preset time interval, the production logistics activities are regarded as normal. Otherwise, the production logistics activities are regarded as abnormal. Then, the report generating module 25 generates a report according to the diagnosis results and a report template provided by the data maintaining module 21.

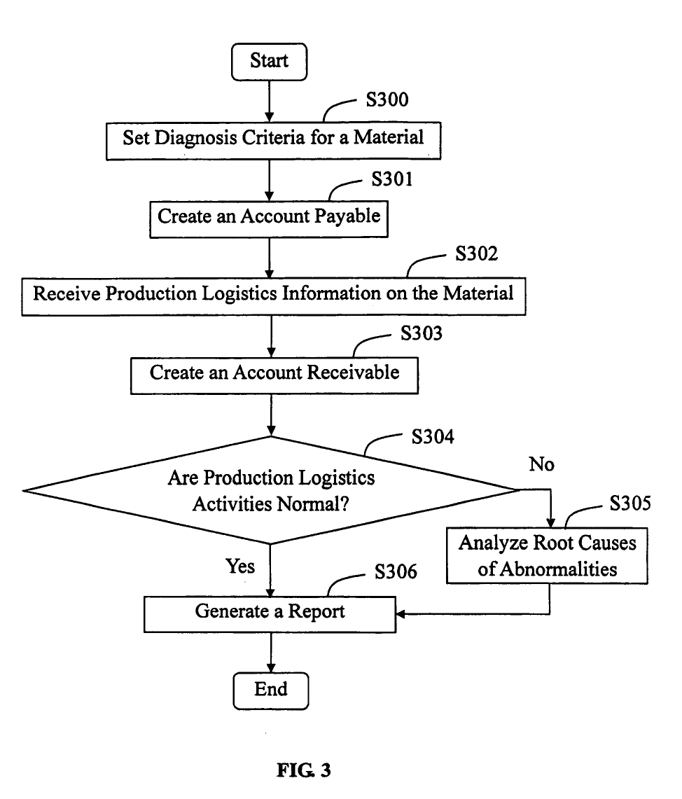

FIG. 3 is a flow diagram of the preferred method for diagnosing abnormal production logistics activities of a material in the possession of a manufacturer, the method being performed by utilizing the system. In step S300, a user sets diagnosis criteria for abnormal production logistics activities of the material, through any one of the user computers 13. In step S301, when the material is purchased and put into stock, the second server 2 creates a goods receipt notice. Then, the account payable creation module 22 creates an account payable according to the goods receipt notice. The account payable comprises an item number, a purchase quantity, a total amount, and an account payable creation date. In step S302, the second server 2 records all production logistics activities of the material in the possession of the manufacturer from the acquisition of the material to the completion of production of a corresponding end product, and transmits the production logistics information to the first server 1. In step S303, when the end product is sold to a customer, the first server receives a sales slip from the second server 2. The account receivable creation module 23 creates an account receivable, which records a sale price and an account receivable creation date. In step S304, the BOM breakdown sub-module 231 breaks down the account receivable into accounts receivable of all the constituent materials of the end product according to a BOM of the end product, thereby obtaining a usage quantity, a manufacturing cost and an account receivable creation date for each material. The abnormality determining module 24 compares the account receivable creation date of the material with its account payable creation date, and determines whether the time period between the account receivable creation date and the account payable creation date is less than or equal to a preset time interval specified in the diagnosis criteria.

If the time period of the material is less than or equal to the preset time interval, the abnormality determining module 24 regards the production logistics activities of the material in the possession of the manufacturer as normal. In such case, the procedure goes directly to step S306 described below. Otherwise, if the time period of the material exceeds the preset time interval, the abnormality determining module 24 regards the production logistics activities of the material as abnormal. In such case, in step S305, the abnormality determining module 24 retrieves the production logistics information on the material, and searches for statuses of the material during various production stages in the manufacture of the end product. The server 1 transmits the search results to the user computer 13 for the user to analyze possible root causes of the abnormalities, in order that future similar abnormalities that may occur in the production logistics activities can be reduced or even eliminated. The procedure then goes to step S306 described below.

In step S306, the report generating module 25 generates a report according to the diagnosis results and a selected template provided by the data maintaining module 21. If analysis was performed in step S305, the report also includes results of such analysis. Thereupon the procedure is finished.

Although the present invention has been specifically described on the basis of a preferred embodiment and preferred method, the invention is not to be construed as being limited thereto. Various changes or modifications may be made to the embodiment and method without departing from the scope and spirit of the invention.

1. A system for diagnosing production logistics abnormalities, the system comprising a first server and a second server, wherein:
the second server transmits production logistics information to the first server; and
the first server analyzes the received information, and determines whether production logistics activities of a material are abnormal, the first server comprising:
a data maintenance module for maintaining information needed for diagnosing the production logistics activities, the data maintenance module comprising a criteria setting sub-module for setting diagnosis criteria;
an account payable creation module for creating an account payable when the material is purchased, the account payable including an account payable creation date;
an account receivable creation module for creating an account receivable when an end product incorporating the material is sold, the account receivable including an account receivable creation date; and
an abnormality determining module for comparing a time period between the account payable creation date and the account receivable creation date and a preset time interval, in order to determine whether the production logistics activities of the material are abnormal.

2. The system according to claim 1, further comprising one or more user computers, each of the user computers providing a user interface, the user interface being for users to maintain the production logistics information and for displaying diagnosis results.

3. The system according to claim 1, further comprising a database for storing the production logistics information and the diagnosis results.

4. The system according to claim 1, wherein the first server further comprises a report generating module for generating a diagnosis report according to the diagnosis results.

5. The system according to claim 1, wherein the account receivable creation module comprises a bill of material (BOM) breakdown sub-module, for breaking down the account receivable into accounts receivable of all constituent materials of the end product according to a BOM of the end product.

6. A computer-based method for diagnosing production logistics abnormalities of a material in the possession of a manufacturer, the method comprising the steps of:
setting diagnosis criteria for abnormal production logistics activities, the diagnosis criteria including a preset time interval for the material;
creating an account payable when the material is purchased, the account payable including an account payable creation date;
receiving production logistics information on the material in the possession of the manufacturer;
creating an account receivable when an end product incorporating the material is sold, the account receivable including an account receivable creation date; and
comparing a time period between the account payable creation date and the account receivable creation date with the preset time interval, to determine whether the production logistics activities of the material are abnormal.

7. The method according to claim 6, further comprising the step of analyzing root causes of abnormalities, if the production logistics activities of the material are abnormal.

8. The method according to claim 7, further comprising the step of generating a diagnosis report according to diagnosis results.

9. The method according to claim 8, wherein the diagnosis report includes results of the analysis of root causes.

10. A method for monitoring production logistics of a manufacturer, comprising the steps of:
setting diagnosis criteria of said production logistics for a predetermined kind of material used to manufacture an end product;
generating information of an account payable corresponding to every purchase of said material;
generating information of an account receivable corresponding to every sale of said end product; and
acquiring actual production information based on said information of said account payable and said account receivable so as to get a result by comparing said actual production information with said diagnosis criteria.

11. The method according to claim 10, further comprising the step of acquiring production logistics information related to said material so as to analyze said information of said account receivable exclusively for said material in order to facilitate said acquiring step.

12. The method according to claim 11, further comprising the step of analyzing causes of said result based on said production logistics information in case that said result is regarded as abnormal.

13. The method according to claim 10, wherein said diagnosis criteria include a preset time interval used to compare with a time period of said actual production information acquired from date information of said information of said account payable and said account receivable.

14. The method according to claim 10, further comprising the step of generating a report stating said result based on a preset template.
